(19) United States
(12) Patent Application Publication
(10) Pub. No.: US 2020/0167813 A1
(43) Pub. Date: May 28, 2020

(54) INFORMATION PROCESSING APPARATUS, INFORMATION PROCESSING SYSTEM, AND INFORMATION PROCESSING METHOD

(71) Applicant: TOSHIBA TEC KABUSHIKI KAISHA, Tokyo (JP)

(72) Inventor: Hiromi SAITO, Izunokuni Shizuoka (JP)

(21) Appl. No.: 16/565,262

(22) Filed: Sep. 9, 2019

(30) Foreign Application Priority Data
Nov. 26, 2018 (JP) 2018-220683

(51) Int. Cl. G06Q 30/02; G06Q 20/34

(52) U.S. Cl. CPC G06Q 30/0207; G06Q 20/349

(57) ABSTRACT

In accordance with an embodiment, an information processing apparatus includes an output device and a processor. If the processor determines that a total value of a charge amount and a total value of a payment amount do not fulfill a predetermined offering condition of a reward, the processor calculates a shortage of the calculated total value of the charge amount or a shortage of the calculated total value of the payment amount with respect to the predetermined offering condition determined as being unfulfilled. Moreover, the processor causes the output device to output the calculated shortage of the total value of the charge amount or the calculated shortage of the total value of the payment amount and a description of the reward related to the predetermined offering condition determined as being unfulfilled.

### CROSS-REFERENCE TO RELATED APPLICATION

This application is based upon and claims the benefit of priority from the prior Japanese Patent Application No. 2018-220683, filed on Nov. 26, 2018, the entire contents of which are incorporated herein by reference.

### FIELD

An embodiment described here generally relates to an information processing apparatus, an information processing system, and an information processing method.

### BACKGROUND

In recent years, payment using an electronic money card of a prepaid type and the like as a type of payment is permitted in addition to cash at a retail store such as a supermarket and a convenience store. Further, at the retail store, a reward such as reward points is offered if an amount (charge amount) prepaid by recharging fulfills a predetermined condition in order to promote prepaid-type payment.

However, there are some customers who come to the retail store, only recharges a charge amount for the purpose of receiving offered rewards, and perform payment by cash. In this case, recharge of the charge amount can be promoted while payment using the charge amount cannot be promoted because the recharged charge amount is not used.

### BRIEF DESCRIPTION OF THE DRAWINGS

FIG. 1 is a perspective view showing an example of an outer appearance configuration of a POS terminal according to an embodiment.

FIG. 2 is a block diagram showing an example of a hardware configuration of a POS system including a POS terminal according to the embodiment.

FIG. 3 is a diagram showing an example of a data configuration of a condition setting file according to the embodiment.

FIG. 4 is a block diagram showing an example of a function configuration of the POS terminal according to the embodiment.

FIG. 5 is a diagram showing an example of an output result of an output processing module of the POS terminal according to the embodiment.

FIG. 6 is a flowchart showing an example of charge processing to be performed by the POS terminal according to the embodiment.

FIG. 7 is a flowchart showing an example of determination processing to be performed by the POS terminal according to the embodiment.

### DETAILED DESCRIPTION

In accordance with one embodiment, an information processing apparatus acquires, from an external storage apparatus or a storage medium possessed by a customer, information on a charge history regarding a charge amount recharged as prepaid money by the customer and information on a payment history regarding payment amount paid from the charge amount. The information processing apparatus includes a communication device, an output device, and a processor. The communication device communicates with the external storage apparatus or the storage medium to thereby receive the information on the charge history and the information on the payment history. The output device outputs information regarding the charge amount or the payment amount and information regarding a reward to be offered to the customer. The processor acquires the information on the charge history and the information on the payment history via the communication device. The processor calculates, on the basis of the acquired information on the charge history and the acquired information on the payment history, a total value of the charge amount and a total value of the payment amount. The processor determines whether or not the calculated total value of the charge amount and the calculated total value of the payment amount fulfill a predetermined offering condition related to offering of the reward. The processor calculates a shortage of the calculated total value of the charge amount or a shortage of the calculated total value of the payment amount with respect to the predetermined offering condition determined as being unfulfilled if the processor determines that the calculated total value of the charge amount and the calculated total value of the payment amount do not fulfill the predetermined offering condition. In addition, the processor causes the output device to output the calculated shortage of the total value of the charge amount or the calculated shortage of the total value of the payment amount and a description of the reward related to the predetermined offering condition determined as being unfulfilled.

Hereinafter, an information processing apparatus, an information processing system, an information processing method, and a program according to an embodiment will be described with reference to the drawings in detail. In the drawings, identical symbols denote identical or similar parts. Here, an example in which the information processing apparatus according to the embodiment is applied to a point of sales (POS) terminal 1 to be used at a retail store (store) such as a supermarket and a convenience store. However, the embodiment is not limited to one described below. The POS terminal 1 acquires, from an external storage apparatus 120 or a storage medium 110 possessed by the customer, information on a charge history regarding a charge amount recharged as prepaid money by the customer and information on a payment history regarding payment amount paid from the charge amount.

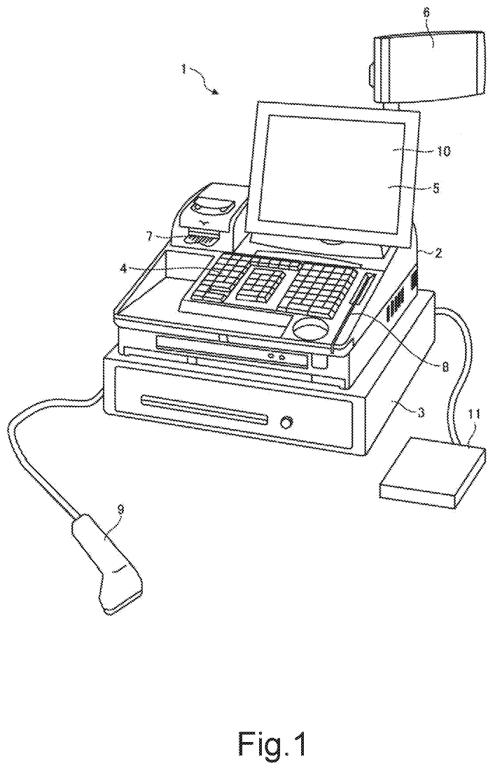

FIG. 1 is a diagram showing an example of an outer appearance configuration of a POS terminal 1 according to this embodiment. As shown in FIG. 1, the POS terminal 1 includes a main apparatus 2 and a cash storage device 3. The main apparatus 2 includes an operation device 4, a card reader 8, a code reader 9, a touch panel 10, a communication device 30, and an output device 40.

The main apparatus 2 further includes a built-in power supply device and a built-in circuit board which are not shown in the figures. The cash storage device 3 includes a drawer and stores cash received from a customer and prepared change.

The operation device 4 is a keyboard including various operation keys such as numeric keys, function keys, and a subtotal key for terminating commodity registration and making instruction to start payment, for example.

The output device 40 outputs information regarding a charge amount or a payment amount and information regarding a reward to be offered to a customer. The output device 40 includes a store-employee display device 5, a customer display device 6, and a printing device 7. The store-employee display device 5 includes a liquid-crystal display, for example. The store-employee display device 5 is placed facing a store employee. The store-employee display device 5 displays literal character(s) and image(s). Specifically, for example, the store-employee display device 5 displays, on a display screen, a shortage of the total value of the charge amount or a shortage of the total value of the payment amount which is calculated by a processor 21 to be described later. Moreover, the store-employee display device 5 displays, on the display screen, a description of the reward associated with a predetermined offering condition that the processor 21 to be described later determines that the total value of the charge amount and the total value of the payment amount do not fulfill, for example. The touch panel 10, which is transparent, is provided on a surface of the store-employee display device 5 and also functions as an input device. For example, the store employee can touch a key portion on the touch panel 10, which is displayed by the store-employee display device 5, and can operate the keys displayed by the store-employee display device 5.

The customer display device 6 includes a liquid-crystal display, for example. The customer display device 6 is placed facing the customer. The customer display device 6 displays literal character(s) and image(s). Specifically, for example, the customer display device 6 displays, on the display screen, a shortage of the total value of the charge amount or a shortage of the total value of the payment amount which is calculated by the processor 21 to be described later. Moreover, the customer display device 6 displays, on the display screen, the description of the reward associated with the predetermined offering condition that the processor 21 to be described later determines that the total value of the charge amount and the total value of the payment amount do not fulfill.

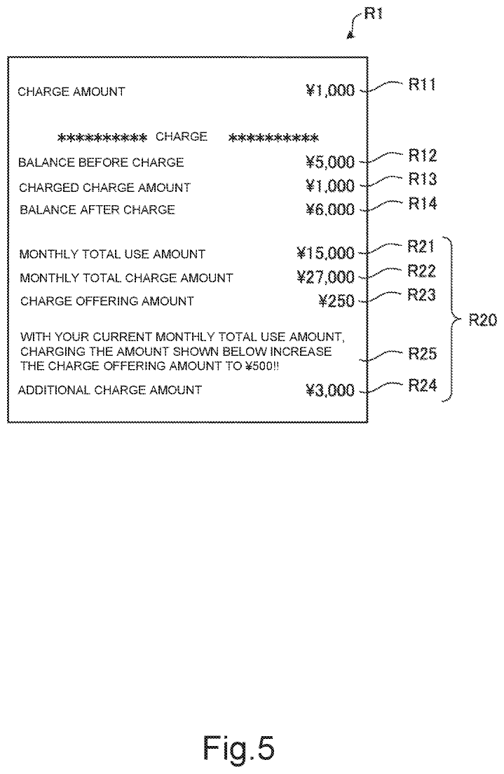

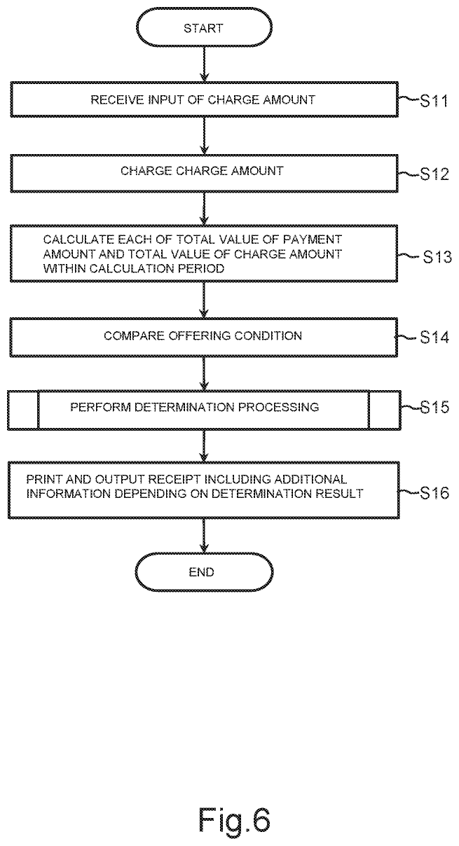

The printing device 7 includes a thermal head, a storage portion that stores a paper roll, and a conveyance portion (all are not shown in the figure), and the like. The printing device 7 outputs (issues) a sheet on which a breakdown and the like of a commercial transaction have been printed. Specifically, for example, the printing device 7 prints, on the receipt, the shortage of the total value of the charge amount or the shortage of the total value of the payment amount which is calculated by the processor 21 to be described later (e.g., see FIG. 6). The printing device 7 also prints, on the receipt, the description of the reward associated with the predetermined offering condition that the processor 21 to be described later determines that the total value of the charge amount and the total value of the payment amount do not fulfill (e.g., see FIG. 5).

The card reader 8 includes a scanner (not shown) that reads out card information from a card medium such as a members card in which a customer identifier for identifying the customer has been stored. The code reader 9 reads out a code symbol such as a barcode added to the commodity and inputs code information (commodity code) included in the code symbol into the POS terminal 1.

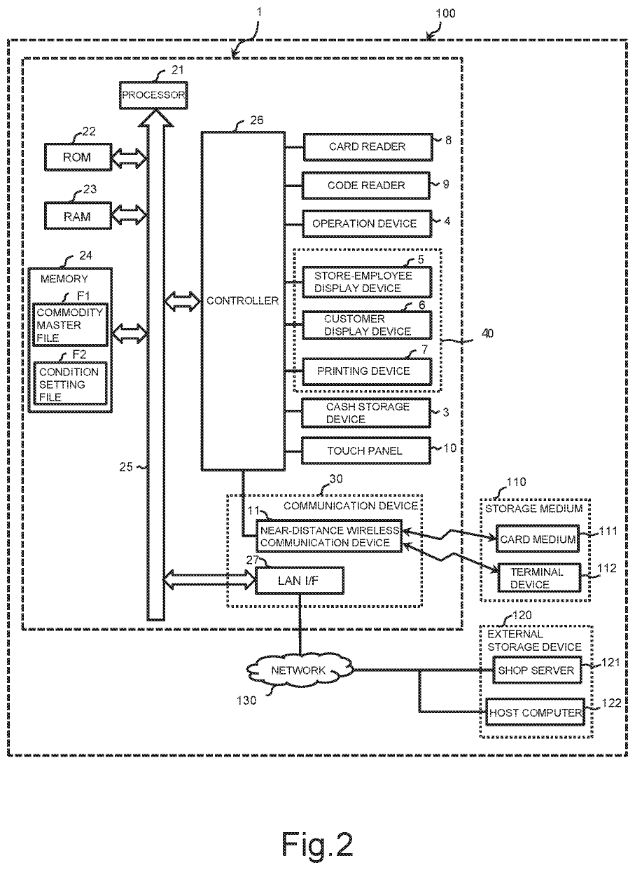

The communication device 30 communicates with the external storage apparatus 120 shown in FIG. 2 or the storage medium 110 shown in FIG. 2 to thereby receive the information on the charge history and the information on the payment history. The communication device 30 includes a near-distance wireless communication device 11 shown in FIG. 1 and a local area network (LAN) interface (I/F) shown in FIG. 2. A near-distance wireless communication device 11 is a communication device according to a near-distance wireless communication standard of a radio frequency identifier (RFID), a nearfield communication (NFC), or the like. The near-distance wireless communication device 11 performs near-distance wireless communication with the storage medium 110 possessed by the customer. The storage medium 110 stores information on the charge amount related to prepaid payment. The near-distance wireless communication device 11 reads out the information on the charge amount related to prepaid payment from the storage medium 110 and inputs the read-out information into the POS terminal 1. It should be noted that FIG. 1 shows an example in which the near-distance wireless communication device 11 is externally attached to the POS terminal 1, though not limited thereto. The near-distance wireless communication device 11 may be provided integrally with the POS terminal 1. Further, the near-distance wireless communication device 11 may be arranged facing the customer similarly to the customer display device 6.

Here, any type and shape can be employed for the storage medium 110 possessed by the customer as long as the storage medium 110 possessed by the customer is communicable with the near-distance wireless communication device 11. The storage medium 110 includes a card medium 111 such as a prepaid electronic money card on which a contactless IC chip is mounted, for example. Further, the storage medium 110 includes a terminal apparatus 112 such as a smartphone, for example. Further, the information on the charge amount includes a prepaid amount (hereinafter, referred to as a charge amount), information related to data communication with a host computer 122 that provides a prepaid service, and the like. Further, the storage medium 110 may have a function as a members card.

FIG. 2 is a block diagram showing an example of a hardware configuration of a POS system 100 including the POS terminal 1. The POS system 100 is an example in which an information processing system according to the embodiment is applied. As shown in FIG. 2, the POS system 100 includes the POS terminal 1, the storage medium 110, and the external storage apparatus 120. The POS terminal 1 includes the processor 21, a read only memory (ROM) 22 and a random access memory (RAM) 23. The processor 21 is a central processing unit (CPU), for example. The processor 21 comprehensively controls the respective blocks of the POS terminal 1. The ROM 22 and the RAM 23 are connected to the processor 21 via a bus line 25 such as an address bus and a data bus. Further, a controller 26 is connected to the processor via the bus line 25.

A memory 24 is a nonvolatile storage medium, which is readable/rewritable, such as a hard disk drive (HDD) and a solid state drive (SSD). The memory 24 stores various programs and various types of setting information related to operations of the POS terminal 1. Further, the memory 24 stores a commodity master file F1, a condition setting file F2, and the like.

The commodity master file F1 is a file for storing commodity information on a commodity name, a unit price, and the like in association with a commodity code of a commodity to be sold at the store. The commodity code is identification information for identifying the commodity. For example, a Japanese article number (JAN) code or the like can be used as the commodity code.

The condition setting file F2 is a file for storing the predetermined offering condition related to offering of the reward. Specifically, the offering condition includes a predetermined threshold of a charge amount (total value) charged during a predetermined period and a predetermined threshold of a payment amount paid from the charge amount (total value) during the predetermined period. The condition setting file F2 stores a plurality of offering conditions and descriptions of rewards each of which is to be offered when the offering condition is fulfilled.

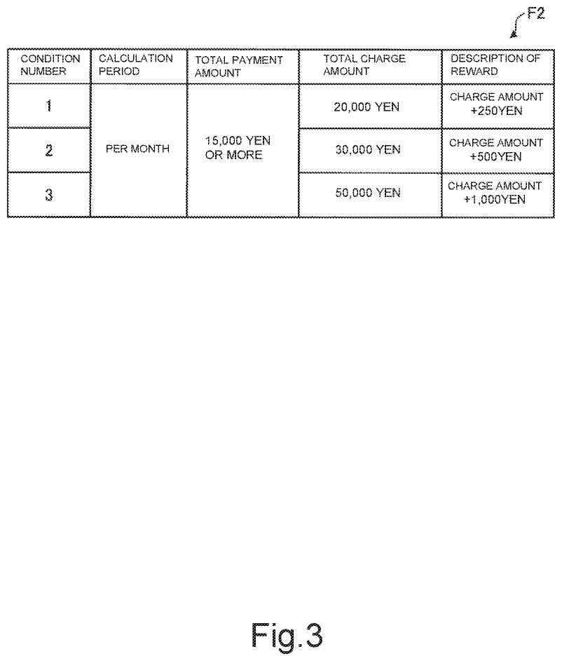

FIG. 3 is a diagram showing an example of a data configuration of the condition setting file F2. As shown in FIG. 3, the condition setting file F2 stores a calculation period, a total payment amount, and a total charge amount, and the description of reward in associated with one another. It should be noted that the condition number is an identifier for identifying each condition.

The calculation period indicates a period (predetermined period) in which the total payment amount (the total value of the payment amount) and the total charge amount (the total value of the charge amount) is calculated. An arbitrary period including a particular period to which date and time are designated and the like as well as “per month”, “per week”, and the like, for example, can be set as the calculation period. In the example of FIG. 3 is an example in which “per month” is set as the calculation period. It should be noted that an initial date in reckoning of “per month” or “per week” is defined in advance.

The predetermined threshold of the payment amount, which is to be the reward offering condition, is set as the total payment amount. Specifically, the threshold of the total value of the payment amount paid in the prepaid payment (charge amount) is set. Further, the threshold of the charge amount, which is to be the reward offering condition, is set as the total charge amount. Specifically, the threshold of the total value of the recharged charge amount is set as the prepaid money.

Here, a combination of the calculation period, the total payment amount, and the total charge amount forms the offering condition related to offering of the reward. Specifically, the fact that the total value of the payment amount paid in the prepaid payment and the total value of the charge amount recharged within a period set as the calculation period fulfill the amount of the threshold of the payment amount and the amount of the threshold of the charge amount which are set to the total payment amount and the total charge amount in FIG. 3 is set as the reward offering condition.

The description of the reward offered when the offering condition including the calculation period, the total payment amount, and the total charge amount is fulfilled is set as the description of the reward. FIG. 3 shows an example in which the charge amount is offered (added) as the description of the reward.

For example, the setting of the condition number “1” provides that a charge amount equivalent to 250 yen is additionally offered in a case where the payment amount (total value) per month is 15,000 yen or more and the charge amount (total value) is 20,000 yen or more. That is, the threshold of the payment amount (total value) is “15,000 yen or more” and the charge amount (total value) is “20,000 yen or more”. Further, the setting of the condition number “2” provides that a charge amount equivalent to 500 yen is additionally offered in a case where the payment amount (total value) per month is 15,000 yen or more and the charge amount (total value) is 30,000 yen or more. That is, the threshold of the payment amount (total value) is “15,000 yen or more” and the charge amount (total value) is “30,000 yen or more”. Further, the setting of the condition number “3” provides that a charge amount equivalent to 1,000 yen is additionally offered in a case where the payment amount (total value) per month is 15,000 yen or more and the charge amount (total value) is 50,000 yen or more. That is, the threshold of the payment amount (total value) is “15,000 yen or more” and the charge amount (total value) is “50,000 yen or more”.

It should be noted that the descriptions of setting of the condition setting file F2 are not limited to the example shown in FIG. 3. For example, the description of reward may be a reward other than offering of the charge amount, such as offering of points.

Referring back to FIG. 2, the controller 26 is connected to the cash storage device 3, the operation device 4, the store-employee display device 5, the customer display device 6, the printing device 7, the card reader 8, the code reader 9, the touch panel 10, and the near-distance wireless communication device 11. The controller 26 performs various types of control on the basis of a command provided from the processor 21.

Further, the bus line 25 is connected to a local area network (LAN) interface (I/F) 27. The LAN I/F 27 is connected to be communicable with another POS terminal 1 or the external storage apparatus 120 including a store server 121, a host computer 122 that provides a prepaid service, and the like via a network 130.

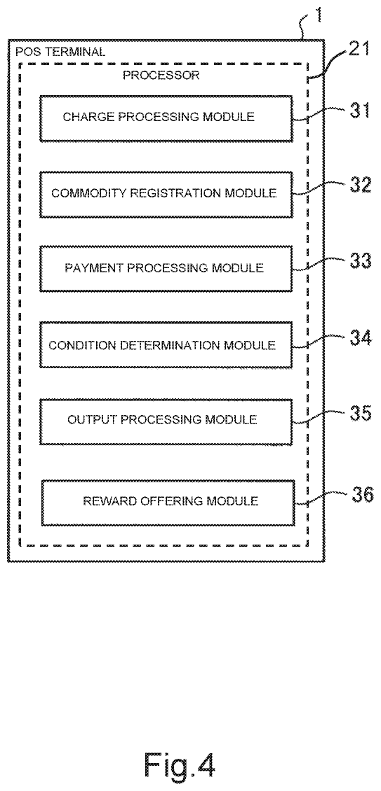

Next, a function configuration of the POS terminal 1 will be described. FIG. 4 is a block diagram showing an example of a function configuration of the processor 21 of the POS terminal 1. As shown in FIG. 4, the processor 21 includes a charge processing module 31, a commodity registration module 32, a payment processing module 33, a condition determination module 34, an output processing module 35, and a reward offering module 36 as functional modules. Those functional modules may be software configurations to be achieved by cooperation of the processor 21 with the programs stored in the memory 24 or may be a hardware configuration achieved by a dedicated circuit or the like mounted on the processor 21 or the like.

The charge processing module 31 of the processor 21 performs processing related to recharge of the charge amount. Specifically, the charge processing module 31 cooperates with the near-distance wireless communication device 11 to thereby perform processing for a customer to recharge (charge) the paid amount (charge amount) as the prepaid money in association with the customer's storage medium 110. Here, associating the charge amount with the customer's storage medium 110 means associating the customer identifier of the customer who possesses the storage medium 110, for example.

Here, it is assumed that any charge method can be employed for the charge amount. For example, the charge processing module 31 may be configured to store the charge amount in the storage medium 110 itself. In this case, the charge processing module 31 performs processing of adding the recharged charge amount to the total value of the charge amount stored in the storage medium 110. Further, for example, in a case of employing a configuration in which the external storage apparatus 120 such as the host computer 122 that provides prepaid service stores and manages the customer identifier of each storage medium 110 and the total value of the charge amount in association with each other is employed, the payment processing module 33 accesses the host computer 122 to thereby perform processing of charging the charge amount. Specifically, the charge processing module 31 sends the customer identifier of the storage medium 110 and the recharged charge amount which are read out via the near-distance wireless communication device 11 to the host computer 122, to thereby perform processing of adding the recharged charge amount to the total value of the corresponding customer identifier.

It should be noted that the history (charge history) of that processing is stored at the time of charging the charge amount. For example, the charge history can be represented as log data in which the charge amount recharged as the prepaid money by the customer and the date and time when the recharge of the charge amount are associated with each other. The storage medium 110 may be used as a storage means. The charge history may be stored in the storage medium 110. Further, the charge history may be stored in association with the customer's storage medium 110 (customer identifier) in the external storage apparatus 120 such as the host computer 122 that provides prepaid service as the storage means.

The commodity registration module 32 performs registration processing for a commodity purchased by the customer. Specifically, the commodity registration module 32 acquires the commodity code from the code symbol read out by the code reader 9. The commodity registration module 32 determines the commodity corresponding to the acquired commodity code on the basis of the commodity master file F1. Then, the commodity registration module 32 registers the commodity by storing, in the memory 24 or the like, sales data in which the commodity code with which the commodity is determined is associated with the number of commodities (the number of items to be purchased), which is additionally input, and the like.

The payment processing module 33 performs payment processing for commodities in one transaction, which are registered by the commodity registration module 32. Specifically, the payment processing module 33 reads out the unit price of each commodity registered by the commodity registration module 32 from the commodity master file F1. The payment processing module 33 calculates a purchase price for each commodity by multiplying the read-out unit price by the number of commodities. In addition, the payment processing module 33 calculates a purchase price (payment amount) of the commodities in the one transaction by summing up the purchase price of each calculated commodity. Then, the payment processing module 33 performs payment processing in which the customer pays the paid amount as the purchase price of the commodities in the one transaction.

Here, the payment processing module 33 is capable of performing payment using cash (cash payment) and prepaid payment using prepaid charge amount as payment methods. In a case of performing prepaid payment, the payment processing module 33 cooperates with the near-distance wireless communication device 11 to thereby perform processing of subtracting the payment amount of the commodities in the one transaction from the total value of the charged charge amount in association with the customer's storage medium 110 (customer identifier).

For example, in a case of employing a configuration in which the charge amount is stored in the storage medium 110 itself, the payment processing module 33 performs processing of subtracting the value equivalent to the payment amount from the total value of the charge amount stored in the storage medium 110. Further, for example, in a case of a configuration in which the external storage apparatus 120 such as the host computer 122 manages the charge amount, the payment processing module 33 accesses the host computer 122 to thereby perform processing of subtracting the value equivalent to the payment amount. Specifically, the payment processing module 33 sends the customer identifier of the storage medium 110, which is read out via the near-distance wireless communication device 11, and the payment amount to the host computer 122, to thereby perform processing of subtracting the value equivalent to the payment amount from the total value of the charge amount associated with the corresponding customer identifier.

It should be noted that at the time of the payment processing for the commodities in the one transaction, the history (payment history) of that processing is stored. The payment history can be represented as log data in which a payment amount paid by the customer for the commodity (or service), the payment method for the payment amount, and the date and time when the payment amount is paid, for example, are associated with one another. The storage medium 110 may be used as the storage means. The payment history may be stored in the storage medium 110. Further, the store server 121 which is the external storage apparatus 120 may be used as the storage means. The payment history may be stored in the store server 121 in association with the transaction number with which the transaction can be identified or the customer identifier of the customer who performs transaction. Further, the host computer 122 that provides prepaid service, which is the external storage apparatus 120, may be used as the storage means. The payment history may be stored in the host computer 122 that is the external storage apparatus in association with the customer's storage medium 110 (customer identifier). Further, in a case of a configuration in which the host computer 122 stores the payment history, the history recorded as the payment history may be one related to the prepaid payment.

The condition determination module 34 is an example of a determination means. On the basis of the offering condition related to offering of the reward which is stored in the condition setting file F2, the condition determination module 34 determines whether or not the total value of the charge amount that the customer charges within the calculation period and the paid the total value of the payment amount that the customer pays as the prepaid payment within the calculation period fulfill the offering condition related to offering of the reward. More specifically, the condition determination module 34 refers to the charge history and the payment history of the customer who possesses the storage medium 110 from which reading out has been performed by the near-distance wireless communication device 11. On the basis of this reference result, the condition determination module 34 determines whether or not the total value of the charge amount and the total value of the payment amount within the calculation period fulfill the offering condition. Hereinafter, determining whether or not the offering condition is fulfilled will be sometimes referred to as fulfilling determination. It should be noted that the condition determination module 34 may refer to the charge history and the payment history of the customer which are acquired from the external storage apparatus 120 via the LAN I/F 27.

It should be noted that any timing can be employed as the timing when the condition determination module 34 performs fulfilling determination of the offering condition. For example, the condition determination module 34 may perform fulfilling determination at the timing when the charge processing module 31 performs charging. Further, the condition determination module 34 may perform fulfilling determination at the timing when the payment processing module 33 performs payment processing (cash payment, prepaid payment). It should be noted that in a case of the cash payment, a customer's history (charge history and payment history) can be determined on the basis of the customer identifier read out from a members card (storage medium), for example.

If the condition determination module 34 determines that any offering condition is fulfilled, the condition determination module 34 selects a condition number of the fulfilled offering condition (see FIG. 3). It should be noted that in a case where a plurality of offering conditions is fulfilled, the condition determination module 34 selects a condition number of one of the offering conditions, which is a condition favorable to the customer. Specifically, regarding each of the fulfilled offering conditions, the condition determination module 34 respectively compares the threshold of the charge amount (total value) and the threshold of the payment amount (total value) which are set as that offering condition with the total value of the charge amount and the total value of the payment amount which are calculated on the basis of the charge history and the payment history of the customer. Then, the condition determination unit 34 selects a condition number of one of the offering conditions, with respect to which the difference is smallest regarding either one of the compared total value of the charge amount or the compared total value of the payment amount or both of the compared total value of the charge amount and the compared total value of the payment amount.

Further, if the condition determination module 34 determines that any offering condition is not fulfilled, the condition determination module 34 selects a condition number of the offering condition and calculates an amount corresponding to the shortage with respect to that offering condition, i.e., an amount corresponding to the shortage required for fulfilling that offering condition. Specifically, the condition determination module 34 respectively compares the threshold of the charge amount (total value) and the threshold of the payment amount (total value), which are set to the fulfilled offering condition, with the total value of the charge amount and the total value of the payment amount, which are calculated on the basis of the charge history and the payment history of the customer. Then, the condition determination module 34 calculates the amount corresponding to the shortage with respect to each of the total value of the charge amount and the total value of the payment amount of the customer, which are compared. Hereinafter, the amount corresponding to the shortage will be referred to as a shortage.

It should be noted that if a plurality of offering conditions is not fulfilled, the condition determination module 34 selects a condition number of one of the offering conditions, with respect to which the shortage is smallest regarding either one of the total value of the charge amount or the total value of the payment amount or both of the total value of the charge amount and the total value of the payment amount. Further, if the fulfilled offering condition and the unfulfilled offering condition are both present, the condition determination module 34 selects a condition number of the fulfilled offering condition and calculates a shortage with respect to the unfulfilled offering condition.

The output processing module 35 is an example of an output means. The output processing module 35 outputs various types of information via the output device 40 (the store-employee display device 5, the customer display device 6, the printing device 7), and the LAN I/F 27 and the like.

For example, the output processing module 35 displays an operation screen for assisting operations of the POS terminal 1 through the store-employee display device 5, to thereby cause the store-employee display device 5 to output various types of information for the store employee.

Further, the output processing module 35 displays a guide screen to the customer through the customer display device 6, to thereby cause the customer display device 6 to output various types of information for the customer. The various types of information include the registration processing and the payment processing of the commodity, the charge breakdown, and the like. Further, the output processing module 35 causes the printing device 7 to output the registration processing and the payment processing of the commodity, the charge breakdown, and the like by issuing a receipt on which the registration processing and the payment processing of the commodity, the charge breakdown, and the like have been printed.

Further, the output processing module 35 causes the output device 40 to output information based on the determination result of the condition determination module 34. Specifically, the output processing module 35 causes the store-employee display device 5, the customer display device 6, and the printing device 7 to output the description of the reward which corresponds to that offering condition with respect to the offering condition determined as being fulfilled. Further, with respect to the offering condition determined as being unfulfilled, the output processing module 35 causes the store-employee display device 5, the customer display device 6, and the printing device 7 to output the description of reward to be offered if the amount corresponding to the shortage is fulfilled. That is, the output processing module 35 causes the output device 40 to output the description of reward associated with the offering condition determined as being unfulfilled in the condition setting file F2 shown in FIG. 3.

FIG. 5 is a diagram showing an example of an output result of the output processing module 35. Here, FIG. 5 shows an example of a receipt R1 on which the output processing module 35 causes the printing device 7 to print and output the charge breakdown. As shown in FIG. 5, a charged charge amount R11 is output as the charge breakdown on the receipt R1. Further, a balance R12 before charge, a charged charge amount R13, and a balance R14 after charge are output as the charge breakdown on the receipt R1. The balance R12 before charge is the total value of the charge amount before charge. The balance R14 after charge is the total value of the charge amount after charge.

Further, additional information R20 depending on the determination result of the condition determination module 34 is printed on the receipt R1. Specifically, a monthly total use amount R21 which is the total value of the payment amount for the calculation period and is extracted from the payment history of the customer and a monthly total charge amount R22 which is the total value of the charge amount for the calculation period and is extracted from the charge history of the customer are printed on the receipt R1.

Further, FIG. 5 shows a case where it is determined (selected) that the offering condition of the condition number “1” shown in FIG. 3 is fulfilled and it is determined (selected) that the offering condition of the condition number “2” is not fulfilled. On the basis of this determination result, the description of the reward (see FIG. 3), which is associated with the offering condition of the condition number “1”, is printed as a charge offering amount R23 on the receipt R1. Further, the amount corresponding to the shortage which is calculated by the condition determination module 34 is output as an additional charge amount R24 (3,000 yen) and a message R25 is printed. The message R25 is for announcing that the description of the reward (a charge offering amount of 500 yen) associated with the condition number “2” is offered when the amount corresponding to the shortage is fulfilled. It should be noted that although FIG. 5 shows the case where the charge amount is insufficient, similar printing is performed also in a case where the payment amount is insufficient.

Accordingly, the customer can easily check the charge amount charged at this time and the current total value of the charge amount by referring to the receipt R1. Further, the customer can check the description of the reward to be offered by referring to the receipt R1 and can easily check which description of reward is to be offered by charging or using a charge amount and a charge amount required for receiving such a reward. Therefore, it is possible to promote charging intention of the customer and also promote the use of the prepaid payment (charge amount).

It should be noted that although the receipt issued when the charge is performed has been described as an example in FIG. 5, a receipt which is an output target of the additional information R20 is not limited thereto. For example, the output processing module 35 may add and output the additional information R20 to a receipt for printing a breakdown of the registration processing and the payment processing for the commodity. Further, an output method for the additional information R20 is not limited to printing of the receipt. The additional information R20 may be displayed on the store-employee display device 5 and the customer display device 6. Alternatively, the additional information R20 may be output to the external storage apparatus 120 via the LAN I/F 27 and the like.

Referring back to FIG. 4, the reward offering module 36 offers the description of the reward associated with that offering condition to the customer in a case where the condition determination module 34 determines that the offering condition is fulfilled. Specifically, the reward offering module 36 cooperates with the charge processing module 31 and performs additional charging while associating the storage medium (the customer identifier) of the charge amount set to the description of the reward with the corresponding customer. In this manner, the reward offering module 36 offers the reward.

It should be noted that although the timing at which the reward offering module 36 offers the reward is not particularly limited, a timing depending on the calculation period of the offering condition is favorably employed. For example, in a case where the calculation period is “per month”, the reward for the previous month is favorably offered on a day after the day when the calculation period elapses.

Next, a control operation of the processor 21 of the POS terminal 1 will be described with reference to FIG. 6. Here, FIG. 6 is a flowchart showing an example of the charge processing to be performed by the processor 21 of the POS terminal 1. It should be noted that for this processing, it is assumed that the near-distance wireless communication device 11 is communicable with the storage medium 110 possessed by the customer, for example.

First of all, in Step S11 of FIG. 6, the charge processing module 31 of the processor 21 receives an input of an amount to be charged (charge amount) via the operation device 4 or the like. Then, in Step S12, the charge processing module 31 performs charge processing of charging an input charge amount in association with the customer's storage medium 110 (customer identifier).

Subsequently, in Step S13, the condition determination module 34 accesses the payment history and the charge history of the customer on the basis of the information (the customer identifier) and the like stored in the storage medium 110, for example. Then, the condition determination module 34 calculates, on the basis of the payment history and the charge history of the customer, each of a total value of the payment amount and a total value of the charge amount within the calculation period (see FIG. 3) set in the condition setting file F2.

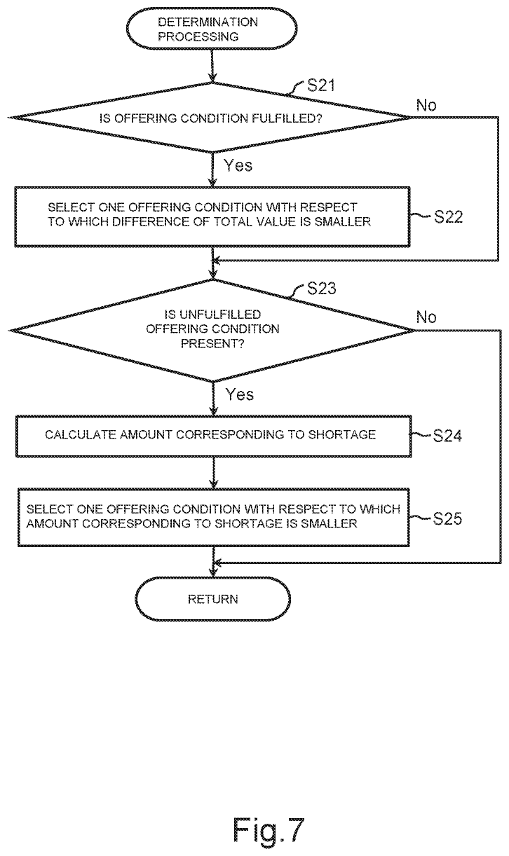

Subsequently, in Step S14, the condition determination module 34 of the processor 21 compares the total value of the payment amount and the total value of the charge amount which are calculated in Step S13 with the threshold of the payment amount (total value) (the total payment amount in FIG. 3) and the threshold of the charge amount (total value) (the total charge amount in FIG. 3) which are set as the offering condition of the condition setting file F2. Then, in Step S15, the condition determination module 34 performs determination processing (see FIG. 7) of determining whether or not the offering condition is fulfilled on the basis of a comparison result in Step S15.

Here, FIG. 7 is a flowchart showing an example of the determination processing to be performed by the processor 21 of the POS terminal 1 (the condition determination module 34). First of all, in Step S21 of FIG. 7, on the basis of the comparison result in Step S14, the condition determination module 34 determines whether or not the total value of the payment amount and the total value of the charge amount which are calculated in Step S13 fulfill any offering condition. If the condition determination module 34 determines that the total value of the payment amount and the total value of the charge amount which are calculated in Step S13 does not fulfill any offering condition (No in Step S21), the processing of the condition determination module 34 shifts to Step S23. Further, if the condition determination module 34 determines that the total value of the payment amount and the total value of the charge amount which are calculated in Step S13 fulfill any offering condition (Yes in Step S21), the processing of the condition determination module 34 shifts to Step S22. In Step S22, the condition determination module 34 calculates a difference between the threshold of the payment amount (total value) and the threshold of the charge amount (total value) (see FIG. 3), which are set as the offering condition determined as being fulfilled, and the total value of the payment amount and the total value of the charge amount, which are calculated in Step S14. Then, the condition determination module 34 selects one of the offering conditions, with respect to which the calculated difference is smallest, from the offering conditions determined as being fulfilled. After the condition determination module 34 selects such an offering condition, the processing of the condition determination module 34 shifts to Step S23.

Then, in Step S23, the condition determination module 34 determines whether or not an unfulfilled offering condition is present with respect to the total value of the payment amount and the total value of the charge amount which are calculated in Step S13. If the total value of the payment amount and the total value of the charge amount which are calculated in Step S13 fulfill all the offering conditions, that is, if the condition determination module 34 determines that the unfulfilled offering condition is not present (No in Step S23), the processing of the condition determination module 34 returns to the processing of FIG. 6 and shifts to Step S16.

On the other hand, if the condition determination module determines that the unfulfilled offering condition is present with respect to the total value of the payment amount and the total value of the charge amount which are calculated in Step S13 (Yes in Step S23), the processing of the condition determination module 34 shifts to Step S24. In Step S24, the condition determination unit 34 calculates a difference between the threshold of the payment amount (total value) and the threshold of the charge amount (total value) which are set as that offering condition and the total value of the payment amount and the total value of the charge amount which are calculated in Step S13 with respect to each of the offering conditions determined as being unfulfilled, that is, a shortage with respect to each of the offering conditions. Then, in Step S25, the condition determination module 34 selects one of the offering conditions, with respect to which the amount corresponding to the shortage calculated in Step S24 is smallest, from the offering conditions determined as being unfulfilled. Aster the condition determination module 34 selects such an offering condition, the processing of the condition determination module 34 returns to the processing of FIG. 6 and shifts to Step S16.

Referring back to FIG. 6, in Step S16, the output processing module 35 of the processor 21 causes the printing device 7 to output the receipt R1 (see FIG. 5) on which the information on the charge amount and the like depending on a result of processing performed in Step S13 and additional information depending on a result of processing of Step S15 have been printed. After the printing device 7 outputs the receipt R1, the processing of the processor 21 shown in FIG. 6 is terminated.

As described above, if the total value of the charge amount that the customer charges within the calculation period and the total value of the payment amount that the customer pays from the charge amount within the calculation period do not fulfill the reward offering condition, the POS terminal 1 outputs the shortage (the charge amount or the payment amount corresponding to the shortage) and the description of the reward to be offered when the shortage is overcome. Accordingly, by referring to a result of output, the customer can easily check what description of reward is to be offered by charging or using a charge amount and a charge amount for receiving such a reward. Therefore, in accordance with the POS terminal 1 according to the embodiment, recharge of the charge amount and payment using that charge amount can be promoted with respect to the customer.

It should be noted that although in the above embodiment, the mode on which the POS terminal 1 stores the commodity master file F1 and the condition setting file F2 is employed, the location where the commodity master file F1 and the condition setting file F2 are stored is not limited thereto. For example, a mode on which the external storage apparatus 120 (the store server 121, the host computer 122, or the like), which the POS terminal 1 is capable of accessing, stores either one of the commodity master file F1 or the condition setting file F2 or both of the commodity master file F1 and the condition setting file F2 are stored may be employed.

Further, although in the above embodiment, the mode on which the apparatus other than the POS terminal 1 stores the payment history and the charge history in the POS system 100 has been described, the location where the payment history and the charge history are stored is not limited thereto. For example, the storage apparatus (storage means) such as the memory 24 of the POS terminal 1 stores either one of the payment history or the charge history or both of the payment history and the charge history in association with the storage medium of the customer (e.g., in association with the customer identifier) may be employed.

Further, although in the above embodiment, the mode on which the POS terminal 1 includes the processor 21 (the reward offering module 36) is employed, a mode on which the apparatus other than the POS terminal 1 includes the reward offering module 36 may be employed. For example, the external storage apparatus 120 such as the host computer 122 that provides the prepaid service other than the POS terminal 1 may include the reward offering module 36. Further, in this case, the external storage apparatus 120 can perform determination of the offering condition and offer the reward at its own apparatus because the external storage apparatus 120 also has the function of the condition determination module 34.

Further, although in the above embodiment, the POS terminal 1 has been described as the information processing apparatus, the information processing apparatus according to the embodiment is not limited to the POS terminal 1. For example, the information processing apparatus according to the embodiment may be applied to a charge amount recharge apparatus specialized for charge. In this case, a processor of the charge amount recharge apparatus at least includes the charge processing module 31, the condition determination module 34, and the output processing module 35 of the functional modules described in the above-mentioned embodiment. Further, the information processing apparatus according to the embodiment may be applied to a terminal apparatus 112 such as a smartphone possessed by the customer, the store server 121, and the external storage apparatus 120 such as the host computer 122 that provides prepaid service. In this case, the terminal apparatus or the external storage apparatus 120 at least includes the condition determination module 34 and the output processing module 35 of the functional modules described in the above-mentioned embodiment. In addition, in the embodiment, the functional modules such as the condition determination module 34 and the output processing module 35 may be achieved by cloud computing via a plurality of information processing apparatuses connected to the network 130.

Further, the programs to be executed by the POS terminal 1 according to the embodiment may be provided, incorporated in a storage medium such as the memory 24 of the POS terminal 1 in advance. Further, although not limited thereto, such programs may be provided, stored in a recording medium readable by the computer such as a CD-ROM, a flexible disk (FD), a CD-R, and a digital versatile disk (DVD) in a file in an installable format or in an executable format. In addition, the above-mentioned storage medium is not limited to the medium independent of the computer or the medium set as the incorporated system. The above-mentioned storage medium may also include a stored or temporarily stored storage medium by downloading a program transmitted via a LAN, the Internet, or the like.

Further, the programs to be executed by the POS terminal 1 according to the embodiment may be stored in the computer connected to the network 130 such as the Internet and may be provided by being downloaded via the network 130. Further, the programs to be executed by the POS terminal 1 according to the embodiment may be provided or distributed via the network 130 such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus that acquires, from an external storage apparatus or a storage medium possessed by a customer, information on a charge history regarding a charge amount recharged as prepaid money by the customer and information on a payment history regarding a payment amount paid from the charge amount, the apparatus comprising:
a communication device that communicates with the external storage apparatus or the storage medium to thereby receive the information on the charge history and the information on the payment history;
an output device that outputs information regarding the charge amount or the payment amount and information regarding a reward to be offered to the customer; and
a processor that
acquires the information on the charge history and the information on the payment history via the communication device,
calculates, on a basis of the acquired information on the charge history and the acquired information on the payment history, a total value of the charge amount and a total value of the payment amount,
determines whether or not the calculated total value of the charge amount and the calculated total value of the payment amount fulfill a predetermined offering condition related to offering of the reward,
calculates a shortage of the calculated total value of the charge amount or a shortage of the calculated total value of the payment amount with respect to the predetermined offering condition determined as being unfulfilled if the processor determines that the calculated total value of the charge amount and the calculated total value of the payment amount do not fulfill the predetermined offering condition, and
causes the output device to output the calculated shortage of the total value of the charge amount or the calculated shortage of the total value of the payment amount and a description of the reward related to the predetermined offering condition determined as being unfulfilled.

2. The information processing apparatus according to claim 1, further comprising
a memory that stores
a plurality of predetermined offering conditions each including the predetermined threshold of the charge amount and the predetermined threshold of the payment amount, and
descriptions of a plurality of rewards each of which is to be offered when the predetermined offering condition is fulfilled, while the plurality of predetermined offering conditions is associated with the descriptions of the plurality of rewards, wherein
if the processor determines that the calculated total value of the charge amount and the calculated total value of the payment amount do not fulfill the predetermined offering condition, the processor
calculates a shortage of the total value of the charge amount with respect to the predetermined threshold of the charge amount of the predetermined offering condition determined as being unfulfilled or a shortage of the total value of the payment amount with respect to the predetermined threshold of the payment amount of the predetermined offering condition determined as being unfulfilled, and
causes the output device to output the calculated shortage of the total value of the charge amount or the calculated shortage of the total value of the payment amount and the description of the reward associated with the predetermined offering condition determined as being unfulfilled.

3. The information processing apparatus according to claim 2, wherein
if the plurality of predetermined offering conditions determined as being unfulfilled is stored in the memory, the processor
calculates a shortage of the total value of the charge amount or a shortage of the total value of the payment amount with respect to the plurality of predetermined offering conditions determined as being unfulfilled,
selects one of the plurality of predetermined offering conditions determined as being unfulfilled, with respect to which the calculated shortage of the total value of the charge amount or the calculated shortage of the total value of the payment amount is smallest, and
causes the output device to output the calculated shortage of the total value of the charge amount or the calculated shortage of the total value of the payment amount with respect to the selected predetermined offering condition and the description of the reward associated with the selected predetermined offering condition.

4. The information processing apparatus according to claim 2, wherein
if the processor determines that the calculated total value of the charge amount and the calculated total value of the payment amount fulfill the predetermined offering condition related to offering of the reward, the processor causes the output device to output the description of the reward associated with the predetermined offering condition determined as being fulfilled.

5. The information processing apparatus according to claim 4, wherein
if the plurality of predetermined offering conditions determined as being fulfilled is stored in the memory, the processor
calculates a difference of the total value of the charge amount from the predetermined threshold of the charge amount of the plurality of predetermined offering conditions determined as being fulfilled or a difference of the total value of the charge amount from the predetermined threshold of the payment amount of the plurality of predetermined offering conditions determined as being fulfilled, and
selects one of the plurality of predetermined offering conditions determined as being fulfilled, with respect to which the calculated difference of the total value of the charge amount or the calculated difference of the total value of the payment amount is smallest, and causes the output device to output the description of the reward associated with the selected predetermined offering condition.

6. An information processing method for an information processing apparatus, the method comprising:
acquiring, from an external storage apparatus or a storage medium possessed by a customer, information on a charge history regarding a charge amount recharged as prepaid money by the customer and information on a payment history regarding payment amount paid from the charge amount via a communication device;
calculating a total value of the charge amount and a total value of the payment amount on a basis of the acquired information on the charge history and the acquired information on the payment history;
determining whether or not the calculated total value of the charge amount and the calculated total value of the payment amount fulfill a predetermined offering condition related to offering of the reward;
calculating a shortage of the calculated total value of the charge amount or a shortage of the calculated total value of the payment amount with respect to the predetermined offering condition determined as being unfulfilled if the processor determines that the calculated total value of the charge amount and the calculated total value of the payment amount do not fulfill the predetermined offering condition; and
causing an output device to output the calculated shortage of the total value of the charge amount or the calculated shortage of the total value of the payment amount and the description of the reward related to the predetermined offering condition determined as being unfulfilled.

7. An information processing system, comprising:
a storage apparatus that stores
information on a charge history regarding a charge amount recharged as prepaid money by the customer, and
information on a payment history regarding payment amount paid from the charge amount;
an output device that outputs information regarding the charge amount or the payment amount and information regarding a reward to be offered to the customer and acquires, from the storage apparatus, the information on the charge history and the information on the payment history; and
a processor that
calculates a total value of the charge amount and a total value of the payment amount on a basis of the acquired information on the charge history and the acquired information on the payment history,
determines whether or not the calculated total value of the charge amount and the calculated total value of the payment amount fulfill a predetermined offering condition related to offering of the reward,
calculates a shortage of the calculated total value of the charge amount or a shortage of the calculated total value of the payment amount with respect to the predetermined offering condition determined as being unfulfilled if the processor determines that the calculated total value of the charge amount and the calculated total value of the payment amount do not fulfill the predetermined offering condition, and
causes an output device to output the calculated shortage of the total value of the charge amount or the calculated shortage of the total value of the payment amount and the description of the reward related to the predetermined offering condition determined as being unfulfilled.

8. The information processing system according to claim 7, wherein
the processor causes the output device to output the description of the reward associated with the predetermined offering condition determined as being fulfilled if the processor determines that the calculated total value of the charge amount and the calculated total value of the payment amount fulfill the predetermined offering condition related to offering of the reward.

9. The information processing system according to claim 7, further comprising
a memory that stores
a plurality of predetermined offering conditions each including the predetermined threshold of the charge amount and the predetermined threshold of the payment amount, and
descriptions of a plurality of rewards each of which is to be offered when the predetermined offering condition is fulfilled, while the plurality of predetermined offering conditions is associated with the descriptions of the plurality of rewards, wherein
if the processor determines that the calculated total value of the charge amount and the calculated total value of the payment amount do not fulfill the predetermined offering condition, the processor
calculates a shortage of the total value of the charge amount with respect to the predetermined threshold of the charge amount of the predetermined offering condition determined as being unfulfilled or a shortage of the total value of the payment amount with respect to the predetermined threshold of the payment amount of the predetermined offering condition determined as being unfulfilled, and
causes the output device to output the calculated shortage of the total value of the charge amount or the calculated shortage of the total value of the payment amount and the description of the reward associated with the predetermined offering condition determined as being unfulfilled.

10. The information processing system according to claim 9, wherein
if the plurality of predetermined offering conditions determined as being unfulfilled is stored in the memory, the processor
calculates a shortage of the total value of the charge amount or a shortage of the total value of the payment amount with respect to the plurality of predetermined offering conditions determined as being unfulfilled,
selects one of the plurality of predetermined offering conditions determined as being unfulfilled, with respect to which the calculated shortage of the total value of the charge amount or the calculated shortage of the total value of the payment amount is smallest, and
causes the output device to output the calculated shortage of the total value of the charge amount or the calculated shortage of the total value of the payment amount with respect to the selected predetermined offering condition and the description of the reward associated with the selected predetermined offering condition, and
if the plurality of predetermined offering conditions determined as being fulfilled is stored in the memory, the processor
calculates a difference of the total value of the charge amount from the predetermined threshold of the charge amount of the plurality of predetermined offering conditions determined as being fulfilled or a difference of the total value of the charge amount from the predetermined threshold of the payment amount of the plurality of predetermined offering conditions determined as being fulfilled,
selects one of the plurality of predetermined offering conditions determined as being fulfilled, with respect to which the calculated difference of the total value of the charge amount or the calculated difference of the total value of the payment amount is smallest, and
causes the output device to output the description of the reward associated with the selected predetermined offering condition.
